(19) United States
(12) Patent Application Publication
(10) Pub. No.: US 2003/0142278 A1
(43) Pub. Date: Jul. 31, 2003

(54) Optical system for projector and projector using it

(76) Inventor: Chikara Yamamoto, Tokyo (JP)

Correspondence Address: Arnold International, P.O. Box 129, Great Falls, VA, 22066, US

(21) Appl. No.: 10/347,318

(22) Filed: Jan. 21, 2003

(30) Foreign Application Priority Data
Jan. 28, 2002 (JP) 2002-018459

(51) Int. Cl. G03B 21/00

(52) U.S. Cl. 353/31

(57) ABSTRACT

A projector and an optical system for a projector are disclosed that use an array of digital micromirrors arranged in a plane to create an image. Each micromirror is rotatable between an ON and an OFF position to modulate incident light by directing it in a first or in a second direction. A prism system receives light from the array of micromirrors and includes a first prism, an air gap layer, a second prism, and an air interface that may be a second air gap layer between the second prism and a third prism. The first and second prisms have top prism surfaces at equal and opposite angles to a normal to the plane of the micromirror array to assure that light reflected from the digital micromirrors in a third direction between the first and second directions is not transmitted through the projector, preventing reduced contrast of a projected image.

### BACKGROUND OF THE INVENTION

Recently, the projector market has been greatly expanding because of market demands for large visual representations from various image sources, such as DVD's, and the use of various electronic devices, such as personal computers, for display on large screens. Among these market demands is the demand for larger high resolution images. That may be achieved by increasing the number of pixels in the projected images, but generally increasing the number of pixels increases the overall size of the optical system. A projector using a digital micromirror device (hereinafter DMD) is a subject of development in order to provide a small optical system with a large numbers of pixels.

A DMD includes an array of digital micromirrors. The digital micromirrors are minute rectangular mirrors (mirror elements), which have a high reflectance and which can change their inclination. The mirror elements are provided on a silicon memory chip produced using CMOS semiconductor technology. An optical system for a projector using a DMD enables the control of the reflection direction of the light from a light source by changing the angle of the mirror elements and enables the projection of a desired picture by converging only the desired reflected light onto a screen. A DMD may, for example, include 2.3 million mirror elements, each element including an aluminum mirror of rectangular configuration, arranged on a substrate 20 mm by 35 mm in size. All the mirror elements can be digitally controlled independently to define separate pixels of a picture. Consequently, a projector using a DMD can provide a picture with several dozen times as many pixels as a conventional average liquid crystal projector, providing higher resolution.

FIGS. 10(a)-10(c) show a construction of a typical DMD. The DMD 3 is a roughly plate-like element and includes an extremely large number of mirror elements that all have a similar construction and all are equipped with a mirror surface, which in a specified state are all aligned within a plane (hereinafter often referred to as the DMD plane) that defines a composite mirror surface 31. FIG. 10(a) shows a portion 34 of the composite mirror surface 31. However, the portion 34 is shown greatly enlarged in FIG. 10(a). FIG. 10(b) shows a further enlargement of the portion 34. As shown in FIG. 10(b), the composite mirror surface 31 is constructed by arranging minute rectangular mirror elements 33 in a two-dimensional array. FIG. 10(c ) shows a cross-sectional view of the portion 34, taken along the line AB as shown in FIG. 10(b). As shown in FIG. 10(c), each mirror element 33 is constructed such that the reflection direction of each mirror element 33 is independently switchable between two directions. The DMD is designed so that this switching of the direction of reflection can be performed by the ON/OFF control of the picture signal(s) connected to the DMD so that each mirror element 33 corresponds to a pixel.

As shown in FIG. 10(c), the inclination of each mirror element 33 can be changed within the range of approximately±10° with respect to the DMD plane (as measured from the surface normals) due to the picture signals. FIG. 10(c) shows the inclination of each mirror element 33, with solid lines showing mirror elements 33 in positions 33a in the ON state when the picture signal is ON and with dash lines showing mirror elements 33 in positions 33b in the OFF state when the picture signal is OFF. FIG. 10(c) also shows the normal NDMD of the entire DMD plane and the normals N₃₃ₐ and N_{33b} of each mirror element 33 at positions 33a and 33b in the ON state and the OFF state, respectively. The light reflected from each mirror element 33 at position 33a, in the ON state, is emitted toward the projection optical system. On the other hand, light reflected from each mirror element 33 at position 33b, in the OFF state, is emitted in a direction that is rotated approximately 40° from the ON state emission direction and does not enter the projection optical system. Whether the mirror element is at the ON position 33a or the OFF position 33b is determined by the picture signal.

In projectors, high contrast is often very important, for example, in movies, and especially with black and white pictures, and therefore improvements in contrast are an important area of development. Japanese Laid-Open Patent Application No. 2000-258730 (which issued as Japanese Patent No. 3090139 and includes the subject matter in U.S. Pat. No. 6,454,417) discloses an optical system for a projector having increased contrast. In this patent, a prism system is used for separating light that has been reflected by mirror elements that are in the ON position and light that has been reflected by the mirror elements that are in the OFF position by relying on the fact that the light reflected from each mirror element of a DMD is emitted in different directions that depend on whether the mirror element is in the ON position or in the OFF position. This prism system prevents the light that has been reflected by the mirror elements that are in the OFF position from entering into the projection optical system, thereby achieving contrast improvement of the projection system.

However, light other than the light reflected by the mirror elements that are in the OFF state may reduce contrast. For example, diffracted light, light reflected from imperfections in the mirror elements, and light reflected from portions other than the reflective surfaces of the mirror elements may reduce contrast. In particular, various surfaces parallel to the DMD plane tend to reflect light that reduces contrast.

More specifically, surfaces that are parallel to the DMD plane and arranged in the vicinity of the DMD tend to reflect light that passes through the optical projection system and this reduces the contrast. For example, a frame portion of the DMD or a cover glass of the DMD may reflect light and reduce contrast. Additionally, outer parts of a prism surface that are parallel to the DMD plane and adjacent the DMD may reflect light, even though coatings may help reduce such reflections. Usually, because the illumination light is passed to a wider area than the composite mirror surface 31 shown in FIG. 10(a), the frame portion 32 of the DMD, which is at the periphery of the composite mirror surface 31, also reflects light. In addition, the materials used for the frame tend to be highly reflective materials.

The reflection of light from surfaces that are parallel to the DMD plane and in the vicinity of the DMD will be explained with reference to FIGS. 11 and 12. FIG. 11 shows the light paths when each mirror element of the DMD 3 is in the ON position. In general, in the optical system for a projector using the DMD, the DMD is arranged so that the central rays of the light reflected from the mirror surfaces 31 are normal to the DMD plane when the mirror elements 33 are in their ON position, and the other optical elements, such as the prisms and air gap layers, are arranged so as to pass that reflected light to the projection optical system. Further, as long as the projection optical system 4 is not designed to be an eccentric system, light rays reflected by the mirror elements 33 that are in the ON position are at least approximately parallel to the optical axis of the projection optical system 4.

As shown in FIG. 11, the prism system 7 includes prisms 73 and 74 that are separated by an air gap layer 71. The illumination light that enters from the left side of the diagram is totally internally reflected at the air gap layer 71 toward the DMD 3. The light that is reflected from each mirror element 33 of the DMD 3 that is in the ON position is reflected in a direction roughly normal to the DMD plane (i.e., along the optical axis). This reflected light will hereinafter be referred to as ON light. Similarly, light that is reflected from each mirror element 33 of the DMD 3 that is in the OFF position will hereinafter be referred to as OFF light. The ON light is projected onto a screen by the projection optical system 4.

On the other hand, FIG. 12 shows the light paths of reflections from a plane 6 which coincides with the DMD plane at the position of the DMD 3 in the optical projection system. This arrangement is one where the normal to the plane 6 becomes roughly parallel to the optical axis of the projection optical system 4 as long as the projection optical system 4 is not designed to be an eccentric system. As shown in FIG. 12, some portions of light reflected from this plane 6 may enter into the projection optical system 4 directly by being re-reflected by an end surface of the prism 7. When these reflected light rays enter into the projection optical system 4, they impair the image by making intended dark pixels too bright, thus reducing contrast.

In the above-mentioned prior art, the possibilities of light entering the projection optical system, especially from surfaces that are parallel to the DMD plane and arranged in the vicinity of the DMD, are not fully considered.

### BRIEF SUMMARY OF THE INVENTION

The present invention relates to a projector and an optical system for a projector that projects light via a prism system, a DMD, and a projection optical system so as to produce images wherein mirror elements of the DMD vary pixel intensities of those images based on their rotational positions between ON and OFF positions according to image signals. The present invention is related to the fact that only light reflected from mirror elements in the ON position is intended to pass through the projection optical system and other light passing through the projection optical system impairs the projected image, for example, by reducing the contrast of the projected image. The present invention is developed in consideration of this fact and relates to a projector and an optical system for a projector that improves contrast of a projected image by preventing not only light from mirror elements of the DMD in the OFF position from passing through the projection optical system, but also other light not reflected from mirror elements of the DMD in the ON position.

### BRIEF DESCRIPTION OF THE DRAWINGS

The present invention will become more fully understood from the detailed description given below and the accompanying drawings, which are given by way of illustration only and thus are not limitative of the present invention, wherein:

FIG. 1 is an enlarged cross-sectional view of the prism system and the DMD portion of the optical system for a projector according to Embodiment 1 of the present invention and shows the center rays of different light fluxes;

FIG. 2 is a cross-sectional view of the projector of Embodiment 1 of the present invention;

FIG. 3 is an enlarged cross-sectional view of the prism system and the DMD portion of the optical system for a projector according to Embodiment 1 of the present invention and shows ON light ray paths;

FIG. 4 is an enlarged cross-sectional view of the prism system and the DMD portion of the optical system for a projector according to Embodiment 1 of the present invention and shows OFF light ray paths;

FIG. 5 is an enlarged cross-sectional view of the prism system and the DMD portion of the optical system for a projector according to Embodiment 1 of the present invention and shows light reflected from planes that are perpendicular to the optical axis (hereinafter termed planar-reflected light);

FIG. 6 is an enlarged cross-sectional view of the prism system and the DMD portion of the optical system for a projector according to Embodiment 2 of the present invention and shows the center ray paths of different light fluxes;

FIG. 7 is an enlarged cross-sectional view of the prism system and the DMD portion of the optical system for a projector according to Embodiment 2 of the present invention and shows ON light ray paths;

FIG. 8 is an enlarged cross-sectional view of the prism system and the DMD portion of the optical system for a projector according to Embodiment 2 of the present invention and shows OFF light ray paths;

FIG. 9 is an enlarged cross-sectional view of the prism system and the DMD portion of the optical system for a projector according to Embodiment 2 of the present invention and shows planar-reflected light;

FIG. 10(a) is a top view of a conventional DMD, with a portion of the DMD shown greatly enlarged;

FIG. 10(b) is a top view with the portion of the DMD shown greatly enlarged in FIG. 10(a) being shown as further enlarged;

FIG. 10(c) is a cross-sectional view of the portion of the DMD shown in FIG. 10(b), taken along the line AB of FIG. 10(b);

FIG. 11 is a side view of a conventional DMD, prism system, and projection lens system and shows reflections from mirror elements in the ON position; and

FIG. 12 is a side view of a conventional DMD, prism system, and projection lens system and shows planar-reflected light from a surface in the plane of the mirror surfaces of the DMD.

### DETAILED DESCRIPTION OF THE INVENTION

A description of the optical system of the present invention will now be provided with regard to Embodiments 1 and 2 and a projector that uses it.

Embodiment 1

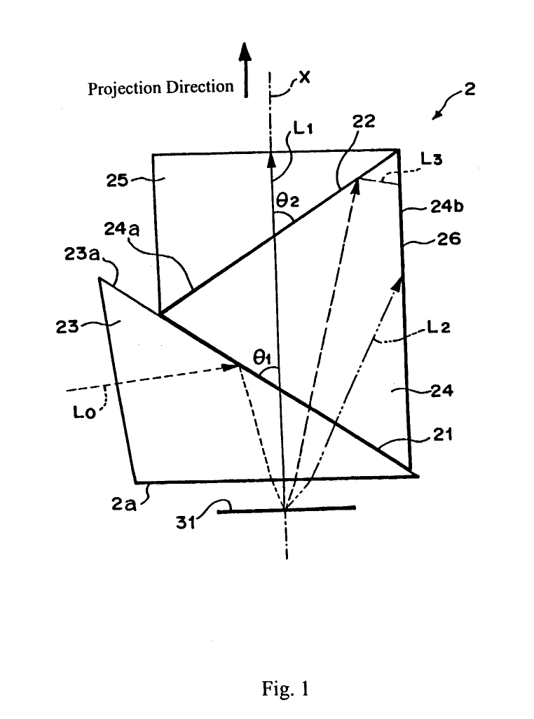

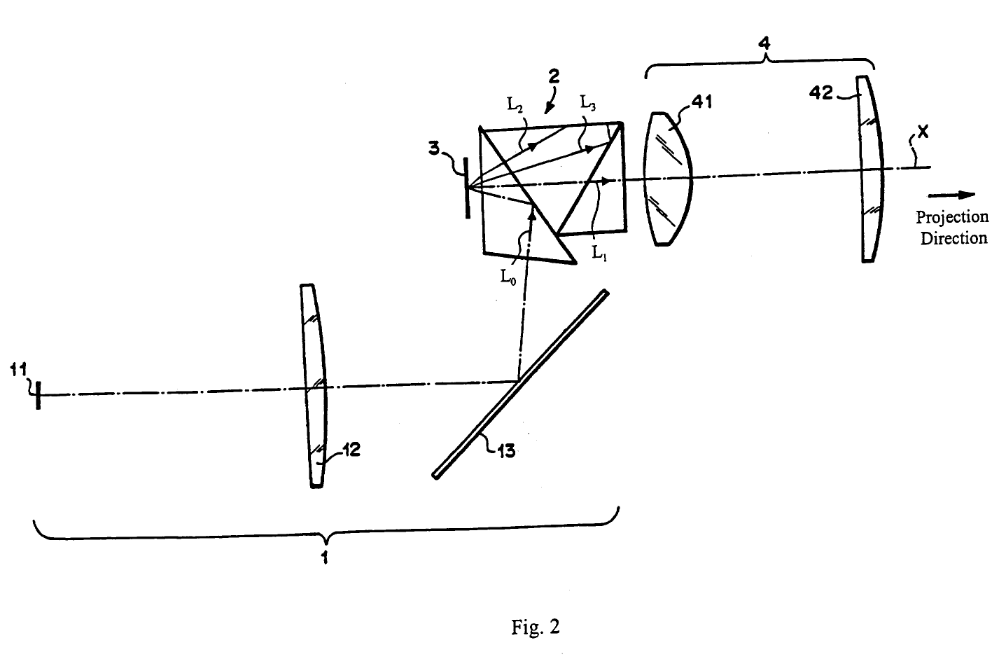

FIG. 2 is a cross-sectional view of the projector of Embodiment 1. As shown in FIG. 2, the optical system for a projector includes an optical irradiation system 1, a prism system 2, a DMD 3, a projection lens system 4 that includes various lens elements, of which only the first lens element 41 and the last lens element 42 are illustrated. FIG. 1 is an enlarged cross-sectional view of the prism system 2 and the DMD portion which includes composite mirror surface 31 of the optical system according to Embodiment 1 of the present invention. As shown in FIG. 1, the prism system 2 includes first and second internal air gap layers 21 and 22, respectively.

Referring again to FIG. 2, the optical irradiation system I includes a light source 11, a condenser lens 12, and a mirror 13. The optical irradiation system I is designed so that light, preferably white light, from the light source 11 is converged by the condenser lens 12 and is reflected by the mirror 13. Referring to FIG. 1, the light that has entered the prism system 2 is reflected by a first air gap layer 21 toward the DMD 3. After it is modulated by the DMD 3, that is, reflected in a selected direction by a controllable DMD element, this light enters into prism system 2 again and passes through the first air gap layer 21 without reflection since the incident angle is less than the critical angle for total internal reflection. However, the light that otherwise would enter the projection optical system is divided at a second air gap layer 22, based on the direction of the light as it strikes the second air gap layer 22. Only light reflected from mirror elements in the ON position is incident onto the second air gap layer at an angle such that it is transmitted through the air gap layer 22 and enters into the projection lens system 4 for projection onto a screen (not shown).

As discussed previously with regard to the prior art, DMD 3 is a roughly plate-like element and includes an extremely large number of mirror elements in an array that all have a similar construction and each equipped with a mirror surface that defines a composite mirror surface 31 in the DMD plane. Each of the mirror elements corresponds to a pixel of an image. The reflection direction for each of the mirror elements, which mirror elements together lie generally in the plane of composite mirror surface 31, is independently switchable to rotate between two angular positions, ON and OFF, to reflect light in two different directions, depending on the ON/OFF control of the picture signal that is sent to each mirror element so as to direct the incoming light with its central light flux, denoted as L₀ in FIG. 1, alternatively either in a first or second direction.

In the following explanation, the position of each mirror element that corresponds to an ON picture signal for that mirror element is referred to as the ON position, and the position that corresponds to the OFF picture signal is referred to as the OFF position. Additionally, for each mirror element, the center of which lies generally in the plane of composite mirror surface 31, the direction of reflected ON light, that is, light reflected from mirror elements in the ON position, is called the first direction, and the direction of reflected OFF light, that is, light reflected from mirror elements in the OFF position, is called the second direction.

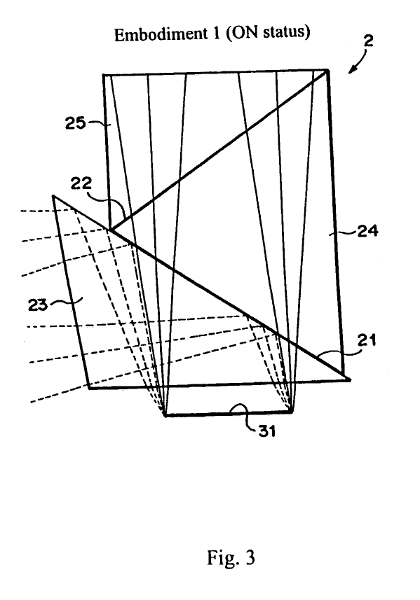

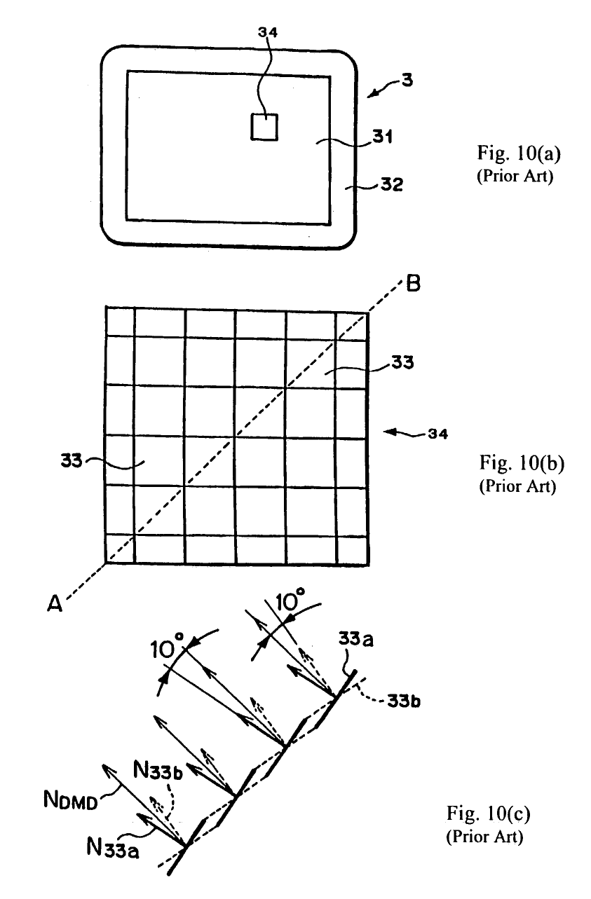

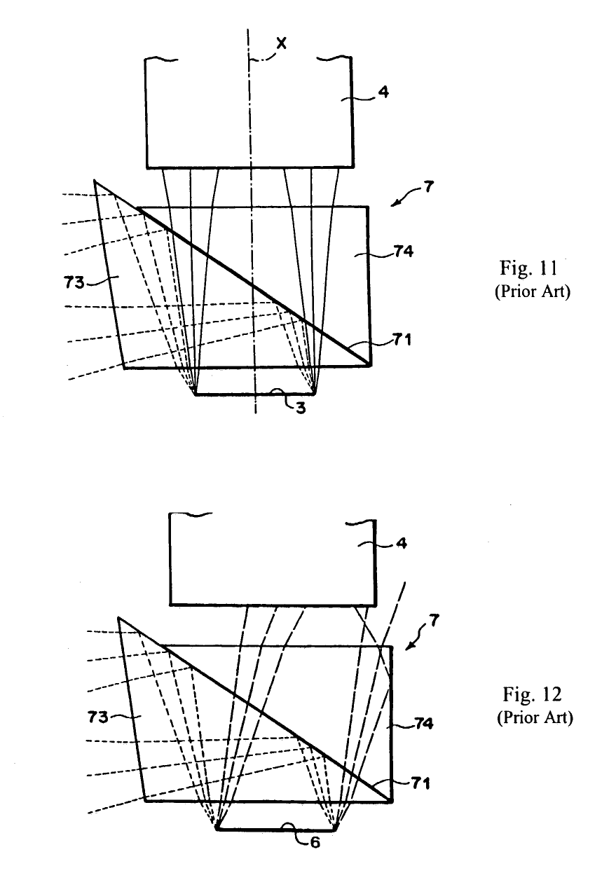

As shown in FIG. 3 and with reference to FIG. 10(c), the optical irradiation system 1, the prism system 2 and the DMD 3 are arranged so that the central rays of the light fluxes reflected from the DMD plane by mirror elements in position 33a, the ON position, are perpendicular (i.e., normal) to the DMD plane. Further, as long as the projection optical system 4 is not designed to be an eccentric system, the central rays of the reflected light fluxes in the ON position coincide with the optical axis of the projection optical system 4. In other words, as shown in FIGS. 1 and 2, for the ON light that is reflected in the first direction, the central light flux L₁ becomes roughly parallel to the normal to the DMD plane, and for the OFF light that is reflected in the second direction, the central light flux L₂ is directed away from the normal to the DMD plane and on the side of the central light flux L₁ that is opposite from the side of the prism system 2 that the illumination light first enters the prism system 2. Furthermore, after the ON light, which becomes a signal light by reflection from each of the mirror surfaces of the DMD 3, passes through the prism 2, it also passes through the projection optical system 4 to a projection screen (not shown).

As shown in FIG. 1, the prism system 2 of Embodiment 1 includes three polyhedral prisms, 23, 24 and 25. The first air gap layer 21 is arranged between the prism 23 and the prism 24, and the second air gap layer 22 is arranged between the prism 24 and the prism 25. The air gap layers 21 and 22 are thin air layers arranged to reflect or transmit light depending upon the incident angle of light to the prism surfaces 23a and 24a of the prisms 23 and 24.

The first air gap layer 21 is arranged so as to deflect and direct the incoming light toward the DMD 3 and to receive light modulated by the DMD. The first air gap layer 21 is arranged so as to totally reflect the incoming light flux, the central light flux of which is denoted by the broken line labeled L₀. The incoming light flux is emitted from the optical irradiation system 1 onto the prism surface 23a at the optical irradiation system side and reflected toward the DMD. The arrangement is such that the direction of incidence of the light flux onto the DMD results in the light reflected from the DMD being directed so that the central light flux thereof is L₁ or L₂ depending on whether the mirror element reflecting the light is in the ON or OFF position, respectively.

Further, the second air gap layer 22 is arranged so as to transmit the ON light that has been reflected in the first direction along the optical axis X (its central light flux is L₁) and to deflect light that has been reflected from surfaces parallel to the DMD plane and in the vicinity of the DMD in a third direction that lies between the first and second directions (its central light flux is L₃). That is, the second air gap layer 22 is arranged so as to transmit the ON light and to totally reflect the light that has been reflected in the third direction in order to separate the ON light from other light than would impair a projected image.

Light reflected in the third direction, with its central luminous flux L₃, is specularly reflected light that is reflected by surfaces that are parallel to the DMD plane and in the vicinity of the DMD plane, such as frame portions 32, as shown in FIG. 10(a), surfaces of a cover glass (not shown), or an outer prism surface such as the outer surface indicated by reference numeral 2a in FIG. 1. Light reflected in the first, second, and third directions may overlap at the prism air gaps. Also, the projection optical system is designed so that each mirror element of the mirror surface has an inclination in the ON position or OFF position depending upon the ON/OFF signal and so that nearly instantaneous switching between the two positions can be achieved. As known in the art, by rapidly switching the mirror for a particular pixel between the two positions for a given frame of an image to be displayed, pixel intensities can be generated between zero and full intensity, as required to display a high quality, black and white or full color image.

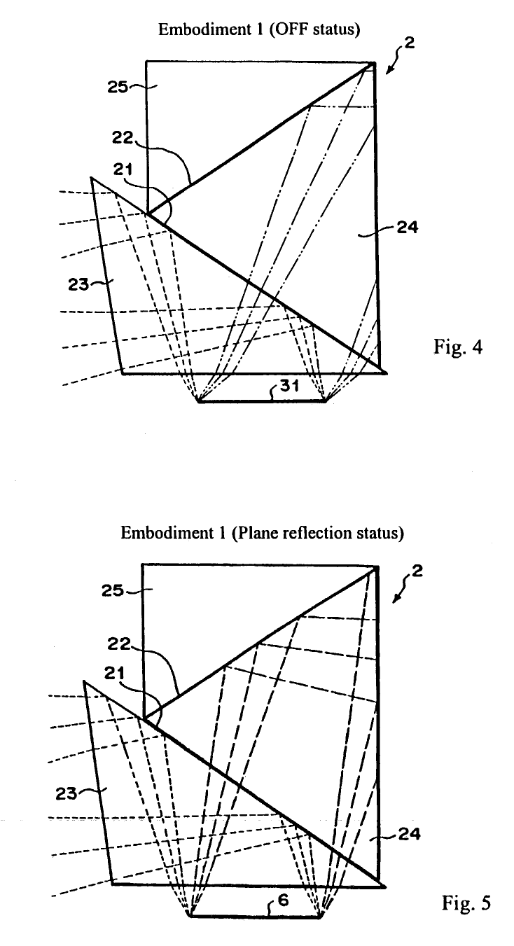

FIG. 3 shows the light flux direction of light reflected from the DMD of Embodiment 1 for ON light that has been reflected in the first direction by mirror elements that are in the ON position and are at the outside periphery of the DMD mirror surface. FIG. 4 similarly shows the light flux direction of light reflected from the DMD of Embodiment 1 for OFF light that has been reflected in the second direction by mirror elements that are in the OFF position and are at the outer periphery of the DMD mirror surface. FIG. 5 similarly shows the light flux direction of light reflected from the edges of a plane 6 that coincides with the DMD mirror surface. In FIG. 3 through FIG. 5, as in FIG. 1, the broken lines indicate the illumination light that is from the optical irradiation system 1; the solid lines indicate the ON light that has been reflected toward the first direction by the mirror elements that are in the ON state; the chain double-dashed lines indicate the OFF light that has been reflected toward the second direction by the mirror elements that are in the OFF state; and the long broken lines indicate the light that has been reflected toward the third direction by specular reflection from the plane 6.

As in the prior art, if light reflected by mirror elements that are in the OFF state, as shown in FIG. 4, were to enter the projection optical system 4, ghosts might be formed on a projection screen by this light or image contrast might be reduced. In Embodiment 1, the second air gap layer 22 is arranged and constructed so that OFF light is not incident onto the second air gap layer with sufficient intensity to cause any degradation of the projected image. Therefore, OFF light does not have to be reflected at the second air gap layer 22.

In addition, in Embodiment 1, light reflected in the third direction is totally reflected at air gap layer 22 and deflected away from the projection optical system. The third direction is generally the direction of light specularly reflected from a surface parallel to the DMD plane that is arranged in the vicinity of the DMD that is shown as plane 6 in FIG. 5. If that reflected light were to enter into the projection optical system 4, it would impair an image by making intended dark pixels too bright, thereby reducing contrast. Embodiment 1 of the present invention prevents that light from entering the projection optical system by reflecting that light at air gap layer 22, as shown in FIG. 5. That is, Embodiment 1 of the present invention prevents not only the OFF light but also light that is specularly reflected on surfaces that are parallel to the DMD plane and in the vicinity of the DMD from reducing image contrast.

In addition, in order to assure that light that is reflected from surfaces that are parallel to the DMD plane and in the vicinity of the DMD in the third direction is also reflected by the second air gap layer 22, it is desirable that the first and second air gap layers 21 and 22 form substantially the same angle in opposite directions with respect to the normal to the DMD plane. In FIG. 1, those equal in magnitude and opposite in sign angles are indicated by angle θ₁, which is the angle between the first air gap layer 21 and the normal to the DMD plane. Because angles θ₁ and θ₂ are equal and, by geometrical optics, the angle of incidence and the angle of reflection of light reflected at surfaces that are parallel to the DMD plane are equal, reflection at the second air gap 22 of light reflected in the third direction is assured. Additionally, forming prisms with equal angles reduces the costs of producing the prisms.

In addition, in Embodiment 1, preferably a light absorption member 26 is placed on prism surface 24b, as shown in FIG. 1, to absorb light that is specularly reflected from the DMD and does not enter the second air gap layer 22, including light directed in the second and third directions and that may or may not have been reflected at the air gap layer 22. For the light absorption member 26, various types are absorption members may be used, such as films or other materials. The use of an absorption member prevents any re-reflection that might eventually result in the re-reflected light entering the projection optical system 4. Furthermore, because the temperature tends to rise on this surface, it is preferable to design for dissipation of heat on this surface, such as by the use of a radiation fin.

Additionally, the prism system 2 may be made larger to help prevent reflected light from entering the projection optical system 4. For example, prism 24 may be extended to the right in FIG. 1 so that some of the light reflected in the second and third directions does not reach air gap layer 22 directly or after reflection from prism surface 24b. Additionally, the prism system 2 may be enlarged so that light reflected in the second and third directions and that is reflected by air gap layer 22 is reflected by prism surface 24b so that it cannot enter the projection optical system 4.

Embodiment 1 uses only one DMD 3. To enable color image projection with such a single DMD, one or more color wheels may be arranged within the optical irradiation system 1, and three color lights, which preferably are red, green, and blue, may be provided to illuminate the DMD 3 in time sequence based on drive control of the color wheel or color wheels coordinated with the color of the picture signal that simultaneously controls the DMD 3. Embodiment 1 may also be used for a video projector for black-and-white image playback.

Embodiment 2

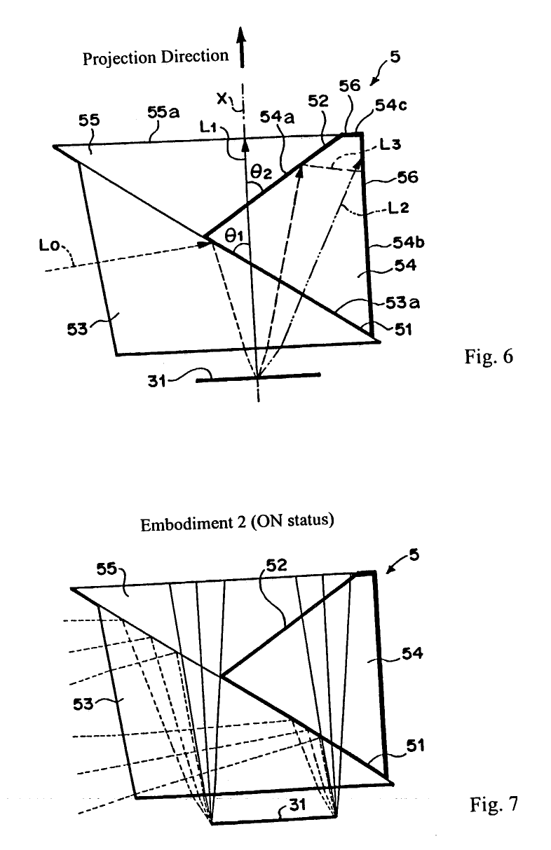

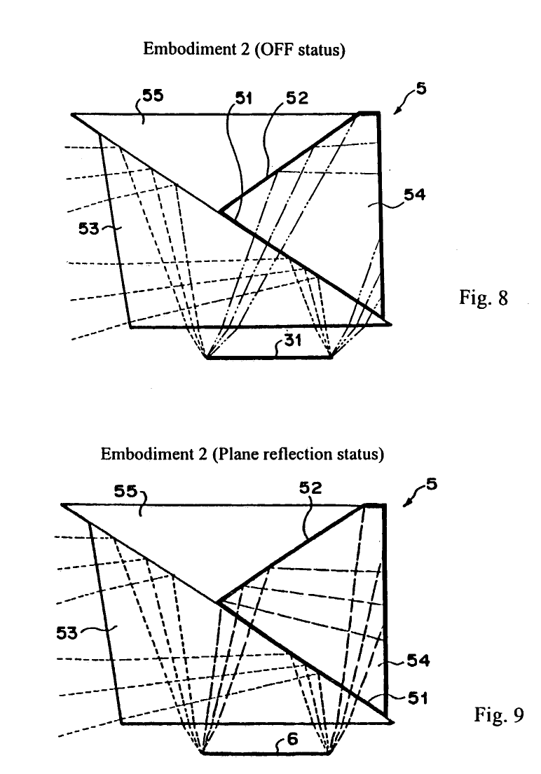

Embodiment 2 of the present invention is the same as Embodiment 1 except for the construction of the prism system. FIG. 6 is an enlarged cross-sectional view of the prism system 5 and the DMD portion of the optical system for a projector of Embodiment 1 of the present invention. FIG. 7 shows the light flux direction of light reflected from the DMD of Embodiment 2 for ON light that has been reflected in the first direction by mirror elements that are in the ON position and are at the outside periphery of the DMD mirror surface. FIG. 8 similarly shows the light flux direction of light reflected from the DMD of Embodiment 2 for OFF light that has been reflected in the second direction by mirror elements that are in the OFF position and are at the outer periphery of the DMD mirror surface. FIG. 9 similarly shows the light flux direction of light specularly reflected from the edges of a plane 6 that coincides with the DMD mirror surface. The light flux direction in FIG. 9 is generally the third direction of reflected light as set forth previously with regard to Embodiment 1.

As shown in FIG. 6, the prism system 5 of Embodiment 2 includes three polyhedral prisms, prism 53 that is triangular in cross-section, prism 54 that has four sides in cross-section, and prism 55 that is triangular in cross-section, with surface 54c of prism 54 and the surface 55a of prism 55 being in the same plane. A first air gap layer 51 is arranged between prism 53 and prism 54, and a second air gap layer 52 is arranged between prism 54 and prism 55.

On the prism surface 53a at the side of the optical irradiation system, the first air gap layer 51 is arranged at a specified position and angle so as to totally reflect the illumination light (its central luminous flux L₀ is indicated with a broken line) from the optical irradiation system 1. The first air gap layer 51 is also arranged so as to transmit the illumination light that has been modulated by the DMD 3 and for which separation is to be performed. Further, on the prism member surface 54a, the second air gap layer 52 is arranged at a specified position and angle so as to transmit the ON light (its central light flux L₁) that has been transmitted through the first air gap layer 51 and to totally reflect other light that has been reflected toward the third direction (its central light flux L₃). Just as before, the OFF light is not incident onto the second air gap layer with sufficient intensity to cause a degradation of the projected image. Thus, separation of the various light fluxes is performed.

As in Embodiment 1, in Embodiment 2, the first and second air gap layers, 51 and 52, form substantially the same angle in opposite directions with respect to the normal to the DMD plane. In FIG. 6, those substantially equal in magnitude and opposite in sign angles are indicated by angle θ₁, which is the angle between the first air gap layer 51 and the normal to the DMD plane, and by angle θ₂, which is the angle between the second air gap layer 52 and the normal to the DMD plane. Because angles θ₁ and θ₂ are substantially equal and, by geometrical optics, the angle of incidence and the angle of reflection of light reflected at surfaces that are parallel to the DMD plane are equal, reflection at the second air gap 52 of light reflected in the third direction is assured. Further, light absorption member 56 is applied to the prism member surfaces 54b and 54c.

The operation of prism system 5 of Embodiment 2 is similar to that in Embodiment 1. At the second air gap layer 52, light that has been specularly reflected from surfaces that are parallel to the DMD plane and that are in the vicinity of the DMD are is totally internally reflected with assurance. Thus, any impairment of imaging by such light, including reduction in the desired contrast, can be prevented. In addition, the prism system 5 of Embodiment 2 may be made thinner than the prism system 2 of Embodiment 1 in the direction from the DMD to the projection optical system 4 (the vertical direction as shown as in FIGS. 1 and 6), thus advantageously reducing both the size and the weight of the prism system and thereby providing a more compact optical system for a projector and a more compact projector incorporating such a prism system.

The present invention is not limited to the aforementioned embodiments, as it will be obvious that various alternative implementations are possible. For example, prism 25 of Embodiment 1 might be omitted and the projection optical system 4 provided at the angle that a light ray normal to DMD plane would be refracted at prism surface 24a, thereby defining a redirection of the optical axis of the optical system of the projector. Such redirection of the optical axis from the normal might be accompanied by other changes to compensate for image variations based on such redirection of the optical axis, such as electronic predistortion of image signals sent to the DMD, aspheric or anamorphic optical elements, or tilting of optical elements, in the projection optical system 4, and/or tilting of a projection screen to compensate for image variations due to the redirection of the optical axis based on the absence of prism 25. In the absence of prism 25, an air interface at prism surface 24a would serve the same purpose as air gap layer 22 in reflecting light that is not in the first direction. Such variations are not to be regarded as a departure from the spirit and scope of the invention. Rather, the scope of the invention shall be defined as set forth in the following claims and their legal equivalents. All such modifications as would be obvious to one skilled in the art are intended to be included within the scope of the following claims.

What is claimed is:

1. An optical system for a projector, the optical system comprising:
an array of digital micromirrors arranged in a plane, each micromirror being rotatable between two positions so as to modulate incident light by reflecting it in a first direction or in a second direction depending on a picture signal that switches the positions of the digital micromirrors between the two positions;
a prism system including, in order from the array of digital micromirrors, a first prism, an air gap layer, a second prism, and an air interface;
the first prism having a prism surface at said air gap layer that is at a first angle as measured with respect to a normal to the plane of the array of digital micromirrors, and the second prism having a prism surface at said air interface that is at a second angle as measured with respect to said normal, and the second angle is substantially equal in magnitude and opposite in direction to said first angle;
wherein
light for illuminating the array of digital micromirrors is deflected at the air gap layer to illuminate the array of digital micromirrors; and
light reflected in the first direction and light reflected in a third direction that lies between the first and second directions is separated at the air interface.

2. The optical system of claim 1, wherein light entering an entrance face of the first prism is reflected from said air gap layer toward the array of digital micromirrors for reflection in one or more of the first, second, and third directions;
light reflected from the array of digital micromirrors in the first direction, the second direction, and the third direction passes back through the first prism and said air gap layer into the second prism;
light reflected in the first direction passes through the second prism into said air interface; and
light reflected in the third direction passes into the second prism and is reflected at said air interface.

3. The optical system of claim 1, further comprising a third prism that includes a prism surface at said air interface opposite the prism surface of the second prism at said air interface so that said prism surfaces of the second and third prisms define a second air gap layer.

4. The optical system of claim 2, further comprising a third prism that includes a prism surface at said air interface opposite the prism surface of the second prism at said air interface so that said prism surfaces of the second and third prisms define a second air gap layer.

5. The optical system of claim 1, wherein the third direction is the direction that a specularly reflecting planar surface placed in the plane of the array of digital micromirrors would reflect light.

6. The optical system of claim 2, wherein the third direction is the direction that a specularly reflecting planar surface placed in the plane of the array of digital micromirrors would reflect light.

7. The optical system of claim 3, wherein the third direction is the direction that a specularly reflecting planar surface placed in the plane of the array of digital micromirrors would reflect light.

8. The optical system of claim 4, wherein the third direction is the direction that a specularly reflecting planar surface placed in the plane of the array of digital micromirrors would reflect light.

9. A projector including the optical system of claim 1.

10. A projector including the optical system of claim 2.

11. A projector including the optical system of claim 3.

12. A projector including the optical system of claim 4.

13. A projector including the optical system of claim 5.

14. A projector including the optical system of claim 6.

15. A projector including the optical system of claim 7.

16. A projector including the optical system of claim 8.
